(19) United States
(12) Patent Application Publication
(10) Pub. No.: US 2026/0304234 A1
(43) Pub. Date: Oct. 1, 2026

(54) SYSTEM AND METHOD FOR ADAPTIVELY ADJUSTING COMMUNICATION CYCLES BETWEEN A VEHICLE, VEHICLE APP, AND CLOUD

(71) Applicant: Volvo Car Corporation, Göteborg (SE)

(72) Inventor: Torgny HEIMLER, Laholm (SE)

(73) Assignee: Volvo Car Corporation, Göteborg (SE)

(21) Appl. No.: 19/095,493

(22) Filed: Mar. 31, 2025

(51) Int. Cl. H04W 28/22; H04W 4/40; H04W 4/50; H04W 64/00

(52) U.S. Cl. CPC H04W 28/22; H04W 4/40; H04W 4/50; H04W 64/00

(57) ABSTRACT

Embodiments relate to a system and method for adaptively adjusting communication cycles between a vehicle, vehicle app, and cloud. The system comprising: a memory storing program instructions; and a processor coupled to the memory and executing the program instructions stored in the memory, wherein the program instructions, when executed by the processor, causes the processor to: obtain information associated with at least one of user behavior, location of a vehicle, vehicle status, and weather conditions; detect patterns associated with usage of a vehicle app based on the information; and modify frequency of communication between the vehicle, the vehicle app, and the cloud server based on the detected patterns.

### TECHNICAL FIELD

This disclosure relates to the field of accessing information related to vehicle status through an application. The disclosure is more particularly related to a system and method for adaptively adjusting communication cycles between a vehicle, vehicle app, and cloud.

### BACKGROUND

Communication between a vehicle and an application associated with the vehicle enables obtaining important statistics of the vehicle remotely. The connection is achieved through a cloud service. However, when a vehicle user opens the application, there is lag in connection typically shown using various progress bars and loading states in the application, since the vehicle and the application do not have a constant connection. Further, the constant connection may drain out the battery of the vehicle.

Therefore, there is a need for a system and method for adaptively adjusting communication cycles between a vehicle, vehicle app, and cloud.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect the present disclosure relates to a system comprising: a memory storing program instructions; and a processor coupled to the memory and executing the program instructions stored in the memory, wherein the program instructions, when executed by the processor, causes the processor to: obtain information associated with at least one of user behavior, location of a vehicle, vehicle status, and weather conditions; detect patterns associated with usage of a vehicle app based on the information; and modify a frequency of communication between the vehicle, the vehicle app, and a cloud server based on the detected patterns.

In another aspect the present disclosure relates to a method comprising: obtaining information associated with at least one of user behavior, location of a vehicle, vehicle status, and weather conditions; detecting patterns associated with usage of a vehicle app based on the information; and modifying frequency of communication between the vehicle, the vehicle app, and a cloud server based on the detected patterns.

In one another aspect the present disclosure relates to a method comprising: A method comprising: obtaining a number of vehicle users associated with a vehicle; obtaining a first information associated with user behavior for each of the vehicle users; obtaining a second information associated with at least one of location of the vehicle, vehicle status, and weather conditions; detecting patterns associated with usage of a vehicle app for each of the vehicle users based on the first information and the second information; and modifying a frequency of communication between the vehicle, the vehicle app, and a cloud server based on the detected patterns.

In yet another aspect the present disclosure relates to a non-transitory computer-readable medium having stored thereon program instructions executable by a processor to perform operations comprising: obtaining information associated with at least one of user behavior, location of a vehicle, vehicle status, and weather conditions; detecting patterns associated with usage of a vehicle app based on the information; and modifying a frequency of communication between the vehicle, the vehicle app, and a cloud server based on the detected patterns.

### BRIEF DESCRIPTION OF THE FIGURES

FIG. 1 illustrates a network diagram associated with a single vehicle user according to an embodiment.

FIG. 2 illustrates a network diagram associated with multiple vehicle users according to an embodiment.

FIG. 3A illustrates a block diagram of a system associated with a vehicle according to an embodiment.

FIG. 3B illustrates a block diagram of electronic components of the vehicle according to an embodiment.

FIG. 4 illustrates a message flow diagram between the vehicle, a vehicle app, and a cloud server according to an embodiment.

FIG. 5A illustrates user behavior information associated with the single vehicle user according to an embodiment.

FIG. 5B illustrates user behavior information associated with multiple vehicle users according to an embodiment.

FIG. 5C illustrates user behavior information associated with the single vehicle user for multiple vehicles according to an embodiment.

FIG. 6 illustrates an example block diagram for an Artificial Intelligence and Machine Learning (AI/ML) model used in a system for adaptively adjusting communication cycles between the vehicle, vehicle app, and the cloud server according to an embodiment.

FIG. 7A illustrates a structure of the neural network/machine learning model with a feedback loop according to an embodiment.

FIG. 7B illustrates a structure of the neural network/machine learning model with reinforcement learning according to an embodiment.

FIG. 8 illustrates a flow chart describing a method for adaptively adjusting communication cycles between the vehicle, vehicle app, and the cloud server according to an embodiment.

FIG. 9 illustrates a block diagram of the system implementing the method for adaptively adjusting communication cycles between the vehicle, vehicle app, and the cloud server according to an embodiment.

FIG. 10 illustrates a block diagram of the method executed by the non-transitory computer-readable medium for adaptively adjusting communication cycles between the vehicle, vehicle app, and the cloud server according to an embodiment.

FIG. 11 illustrates a flow chart describing a method for adaptively adjusting communication cycles between the vehicle, vehicle app, and the cloud server for multiple vehicle users according to an embodiment.

FIG. 12A illustrates the block diagram of the cyber security module in view of the system and server according to an embodiment.

FIG. 12B illustrates an embodiment of the cyber security module according to an embodiment.

FIG. 12C illustrates another embodiment of the cyber security module according to an embodiment.

### DETAILED DESCRIPTION

### Definitions and General Techniques

For simplicity and clarity of illustration, the drawing figures illustrate the general manner of construction, and descriptions and details of well known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein, the term “one of A, B, and C” shall be understood to mean “only A, only B, or only C,” and not a combination of A, B, and C.

As used herein, the term “one or more of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein, the term “at least one of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

As used herein, two or more elements or modules are “integral” or “integrated” if they operate functionally together. Two or more elements are “non-integral” if each element can operate functionally independently.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein, the term “component” broadly construes hardware, firmware, and/or a combination of hardware, firmware, and software.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable storage medium for execution by, or to control the operation of, data processing apparatus. The computer-readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship to each other.

Embodiments may comprise or utilize a special purpose or general purpose computer including computer hardware. Embodiments within the scope of the present disclosure may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes random access memory (RAM), read-only memory (ROM), electrically erasable programmable read-only memory (EEPROM), compact disk read-only memory (CD-ROM) or other optical disk storage (such as compact discs (CDs), digital versatile disks (DVDs), etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Circuit (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, handheld devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

Unless otherwise defined herein, scientific and technical terms used in connection with the present disclosure shall have the meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well known and commonly used in the art.

The methods and techniques of the present disclosure are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well known and commonly used in the art.

The following terms and phrases, unless otherwise indicated, shall be understood to have the following meanings.

As used herein, the term “API” stands for Application Programming Interface. It is an interface that defines interactions between multiple software applications or mixed hardware-software intermediaries. It defines the kinds of calls or requests that can be made, how to make them, the data formats that should be used, the conventions to follow, etc. It can also provide extension mechanisms so that users can extend existing functionality in numerous ways and to varying degrees. An API can be entirely custom, specific to a component, or designed based on an industry-standard to ensure interoperability. Through information hiding, APIs enable modularity, allowing users to use the interface independently of the implementation. Web APIs are now the most common meaning of the term API. There are also APIs for programming languages, software libraries, computer operating systems, and computer hardware.

The network may dynamically derive the APIs. In other implementations, the APIs may be derived from API records that are stored by the network. Additionally, when new APIs are derived for a particular network service, the APIs may be recorded in case a similar network service request (e.g., from another user) is received, in which case the record may be promptly used to determine the appropriate API, or set of APIs, for the requested network service.

The API request (e.g., for a name, an ID, or another type of information in the request) may correspond to network interactions, communications, events, etc., that are to occur in order to provide the network service. Libraries/repositories of the Software Defined Networking (SDN) may also store the chain of network interactions, communications, events, etc. APIs may be derived based on the characteristics of each of the interactions, communications, events, etc., being mapped to characteristics of APIs (also stored in libraries/repositories of the SDN architecture).

Secure application-level data transport widely uses cryptographic protocols. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation.

Networking switches use cryptographic protocols, like Secure Socket Layer (SSL) and Transport Layer Security (TLS), the successor to SSL, to secure data communications over a wireless network.

As used herein, the term “Logging” or “log” is the process of collecting and storing data over a period in order to analyze specific trends or record the data-based events/actions of a system, network, or Information Technology (IT) environment. It enables the tracking of all interactions through which data, files or applications are stored, accessed, or modified on a storage device or application.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN), logistic regression, discriminant analysis, random forest, linear regression, Naive Bayes, nearest neighbor, decision tree, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model, improving the model's accuracy and performance over time.

Statistical modeling relies on finding relationships between variables (e.g., mathematical equations) to predict an outcome.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files. As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “Sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc. The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses, etc., are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), battery electric vehicles (BEVs), and plug-in hybrid electric vehicles (PHEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles. Similarly, a Vehicle-to-Grid (V2G) communication may exchange charge information and further transfer charge from the vehicle to the grid.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware. In an example, the second component can be an energy source capable of charging a vehicle battery and accepting charge from the vehicle battery.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users'applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communication over a network.

The term “communication cycle” or “connection frequency” or “frequency of connection” as used herein refers to a communication session between the vehicle and the vehicle app through a cloud server. For example, a vehicle user may interact with the vehicle app to access information associated with the vehicle through the cloud server.

The term “vehicle user” or “user” as used herein refers to any person associated with the vehicle. The vehicle user may be at least one of an owner of the vehicle, a driver of the vehicle, a family member of the owner of the vehicle, a lessee of the vehicle, a lessor of the vehicle, etc.

The term “vehicle app” or “app” or “application” or “vehicle application” as used herein refers to any software application installed in a user equipment, such as, but not limited to, a mobile phone, laptop, tablet, handheld device, a computer system, etc., associated with the vehicle user for accessing information about the vehicle associated with the vehicle user.

The term “user behavior” as used herein refers to how frequently the vehicle user interacts with the vehicle app to check the status of the vehicle.

The term “location” as used herein refers to a physical location of the vehicle.

The vehicle and the vehicle app communicate via the cloud, for example, to show vehicle status and to handle commands to and from the vehicle and the vehicle app. To communicate the vehicle status and commands, the vehicle and the vehicle app connect to the cloud with a certain frequency. However, the vehicle and the vehicle app will not be in constant connection with the cloud and therefore communication between the vehicle and the vehicle app is typically lagging when the vehicle user opens the vehicle app.

Business Problem: The lag in communication between the vehicle and vehicle app is typically shown by displaying various progress bars and loading states in the vehicle app. This may lead to frustration in the user.

Technical Problem: The vehicle and the vehicle app in a constant connection state with the cloud may not have communication lags but may drain the battery of the vehicle and also consume data from the user device having the vehicle app.

Business Solution: Rather than improving the waiting time for the vehicle user, or connecting to the cloud very frequently, the disclosure aims to minimize the waiting time during the most likely time slots when the vehicle and the vehicle app need to be connected, while still connecting with the cloud as little as possible.

Technical solution: An embodiment relates to a system for adaptively adjusting communication cycles between a vehicle, vehicle app, and cloud. The system logs and analyzes one or more factors to detect patterns and relationships in the usage of the vehicle app. The one or more factors may include such as, but not limited to,
1. Common time slots of interaction, for example, the system may detect that the vehicle user starts the vehicle app every weekday between 7 AM-7:30 AM to check the battery status and the cabin temperature and may log the activity. In some embodiments, the system may consider the variations in the common time slots of interaction during a national holiday or other disrupting events, wherein the disrupting event comprises at least one of: an unexpected weather condition, a health emergency of the vehicle user, an accident associated with the vehicle, and a breakdown condition of the vehicle.
2. A location of the vehicle, for example, the system may detect that the vehicle user interacts with the app more frequently when the vehicle is at a certain location in order to check and control the vehicle.
3. A status of the vehicle: whether the vehicle is standing still or moving.
4. Weather conditions/temperature around the vehicle.
5. Temperature inside the vehicle.
6. Weather forecasts.
7. The vehicle's recent frequency of use. For example, if the vehicle has not been used for several days, the vehicle should communicate less often with the cloud, to preserve battery.
8. The vehicle app's recent frequency of use. For example, if the vehicle is being charged at a public charging station, in combination with other factors, like the driver's seat being empty, the charge is approaching the desired level, the speed and cost of charging, connection between the charging station and the vehicle, etc., may require a more frequent checking of the app.
9. A Locked status of the vehicle.
10. If the cabin temperature operation of the vehicle is running.
11.Whether the user has set a timer for starting the cabin temperature operation.
12.Whether the starting of the app covaries with any command previously/recently performed in the app.

The analysis of app usage in combination with the above mentioned factors results in a “likelihood of interaction” data chart, for an individual vehicle and its associated vehicle user. Based on the “likelihood of interaction” data chart, the system adjusts the frequency cycles such that when app usage is likely to occur, the communication cycles between vehicle/app/cloud shall increase in frequency, to decrease lag and waiting time for the user. On the other hand, when the user is unlikely to use the app, the vehicle and app shall communicate via the cloud less frequently, to save battery and data.

Technical Result: Adaptive communication cycles between the vehicle, vehicle app, and the cloud server provide quick loading of the current vehicle information and, at the same time, conserves the vehicle battery and data usage of the user device.

In some embodiments, a single vehicle may be associated with multiple users and in such conditions the system may log data associated with each user of the vehicle and adjust the communication cycle based on which user is currently using the vehicle. In some embodiments, a single user may have multiple vehicles, and in such conditions the system may log data associated with how the user uses each of the vehicles and adjust the communication cycle based on which vehicle the user is currently using.

In some embodiments, apart from the logged user behavior, the system also takes into consideration the ongoing in-app notifications. For example, if an app-initiated warning message, related to the vehicle, shows up on the user equipment, the vehicle may need to communicate with the cloud more frequently for a period of time, since the likelihood of the user checking the status of the vehicle may increase after the warning message.

In some embodiments, in-app notifications may include having a message indicating a slower connection during adverse weather conditions, wherein the message may include a timestamp to indicate when the last update occurred. For example, during a first snow of the season at seven o'clock on a Monday morning, connections will be slower, as the cloud server may be busy with a lot of requests. In such case an in-app notification saying “server busy please try after X minutes” may help the vehicle user to understand that the vehicle information shown by the vehicle is not very recent and the vehicle user may reconnect after X minutes to get the current update.

In some embodiments, apart from logged user behavior, the system also takes into consideration if the vehicle is connected to a grid. For example, if the vehicle is a BEV or PHEV, and is connected to the grid, then more frequent communication between the vehicle, vehicle app, and cloud is required to check the vehicle charging/discharging status.

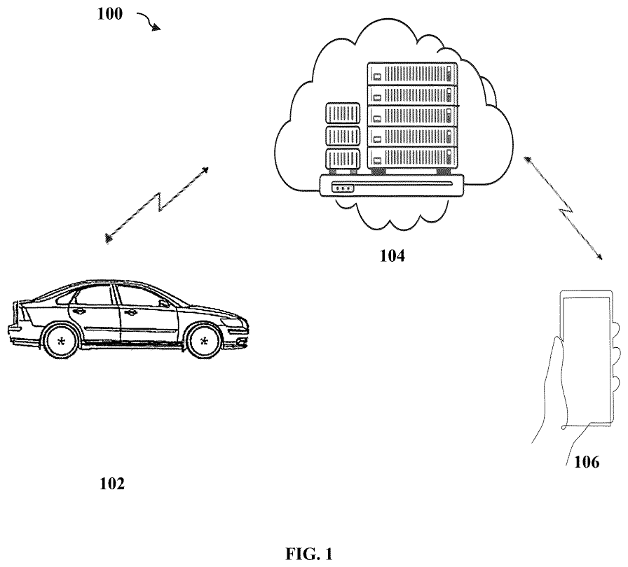

Technical Details Specific to the Technical Solution: FIG. 1 illustrates a network diagram associated with a single vehicle user according to an embodiment.

Referring to FIG. 1, network 100 comprises vehicle 102, cloud server 104, and vehicle user 106, wherein the vehicle user is associated with the vehicle. Vehicle user 106 is associated with a user equipment comprising the vehicle app installed in it. Vehicle user 106 sends one or more commands from the vehicle app to the vehicle through the cloud server 104. In some embodiments, cloud server 104 comprises at least one of a public cloud server, a private cloud server, and a hybrid cloud server. In some embodiments, the vehicle app is provided by at least one of: the manufacturer of the vehicle and a third-party application provider authorized by the vehicle manufacturer. The vehicle app may be installed in the user equipment of the vehicle user at the time of purchase or at the time of registration of vehicle details with the application provider.

In some embodiments, a system for adaptively adjusting communication cycles is provided. The system may comprise memory storing program instructions; and a processor coupled to the memory and executing the program instructions stored in the memory, wherein the program instructions, when executed by the processor, causes the processor to: obtain information associated with at least one of user behavior, location of a vehicle, vehicle status, and weather conditions; detect patterns associated with usage of a vehicle app based on the information; and modify frequency of communication between the vehicle, the vehicle app, and the cloud server based on the detected patterns.

In some embodiments, the program instructions further cause the processor to: predict a likelihood for interaction between the vehicle app, the vehicle, and the cloud server based on the detected patterns; and modify the frequency of the communication between the vehicle, the vehicle app and the cloud server based on the prediction.

In some embodiments, the program instructions further cause the processor to: determine presence of at least one of ongoing notifications in the vehicle app and a connection between the vehicle and a grid; and update the prediction based on the presence of at least one of the ongoing notifications in the vehicle app and the connection between the vehicle and the grid.

In some embodiments, the user behavior comprises a frequency associated with the vehicle user interacting with the vehicle app based on at least one of: a time period during a day, the location of the vehicle, and the vehicle status. For example, the vehicle user may keep interacting with the vehicle app for 2-3 times during a particular time of the day (e.g., morning 7:30 AM on a weekday) to check the fuel status of the vehicle before leaving to work, the vehicle user may interact 3-4 times with the vehicle app when the vehicle is parked in public parking to check the safety of the vehicle, or the vehicle user may interact 4-5 times with the vehicle app while charging in a public charging place to check the battery charge level. In other words, user behavior is related to how frequently the vehicle user interacts with the vehicle app in particular situations.

In some embodiments, the time period during the day comprises at least one of: a first time of interaction between a vehicle user and the vehicle app on week days, a second time of interaction between the vehicle user and the vehicle app on weekends, a third time of interaction between the vehicle user and the vehicle app on national holidays, a fourth time of interaction between the vehicle user and the vehicle app on days with disrupting events, a fifth time of interaction between the vehicle user and the vehicle app during peak hours, and a sixth time of interaction between the vehicle user and the vehicle app during off-peak hours.

In some embodiments, the disrupting event comprises at least one of: an unexpected weather condition, a health emergency of the vehicle user, an accident associated with the vehicle, and a breakdown condition of the vehicle.

In some embodiments, the frequency associated with interacting with the vehicle app is determined based on a number of times the vehicle user opens the vehicle app based on at least one of the location of the vehicle, the vehicle status, and during at least one of the first time of interaction, the second time of interaction, the third time of interaction, the fourth time of interaction, the fifth time of interaction, and the sixth time of interaction.

For example, the user may open the app 2-3 times around 7 AM-7:30 AM from Monday to Friday (i.e., the first time of interaction) to check the overall condition of the vehicle before leaving to work, the user may open the app 1-2 times around 10 AM-11 AM on Saturdays and Sundays (i.e., the second time of interaction) to check the vehicle condition before leaving for a long drive, shopping, family outing, etc., the user may open the app 2-4 times around 3 PM-4 PM on national holidays (i.e., the third time of interaction) to check vehicle conditions and weather conditions before planning for an outing, the user may interact with the app 4-5 times around 3 PM-4 PM on a stormy day (i.e., the fourth time of interaction) before driving for essentials, the user may interact with the app 3-4 times to check the fuel and air status in the vehicle around 9 AM-1 PM (i.e., the fifth time of interaction) before leaving for a client meeting, the user may open the app 1-2 times to check the charging status of the vehicle around 8 PM-4 AM (i.e., the sixth time of interaction), etc.

In some embodiments, the location of the vehicle comprises at least one of: a parking place of the vehicle and a charging place of the vehicle, wherein the parking place of the vehicle comprises at least one of a private parking place and a public parking place and wherein the charging place of the vehicle comprises a public charging place and a private charging place.

In some embodiments, the vehicle status comprises at least one of: running status, connection status, ignition status, lock status, and temperature status, wherein the running status comprises at least one of: the vehicle in a parked state and in a moving state.

In some embodiments, the connection status comprises at least one of: the vehicle connected with a charging station for a charging operation, connected with the charging station for a discharging operation, and disconnected from the charging station.

In some embodiments, the ignition status comprises at least one of: vehicle ignition ON, vehicle ignition OFF, a first time duration associated with the vehicle ignition being ON, and a second time duration associated with the vehicle ignition being OFF.

In some embodiments, the lock status comprises at least one of: the vehicle being locked and the vehicle being unlocked.

In some embodiments, the temperature status comprises at least one of: cabin temperature of the vehicle and a preset temperature in the vehicle.

In some embodiments, the weather conditions comprise at least one of: weather forecast and weather conditions surrounding the vehicle.

Referring to FIG. 1, the vehicle user may interact with the vehicle app on the user equipment to access one or more information about vehicle 102 through cloud server 104. For example, if the vehicle user needs to leave for work, the vehicle user may initiate communication with vehicle 102 between 7 AM-7:30 AM using the vehicle app to check the fuel status of the vehicle. The request from the user equipment is sent to vehicle 102 through cloud server 104. Vehicle 102 responds with the fuel level in the vehicle, which is then communicated to the user equipment via the cloud server, and the fuel level is displayed on the display of the user equipment. Further, the cloud server may track the frequency of the user using the app and accordingly maintain the connectivity between the vehicle and the vehicle app. Cloud server 104 may determine that the user is interacting with the app 2-3 times between 7 AM- 7:30 AM on all weekdays and therefore maintains a continuous connection between the vehicle and the vehicle app on all weekdays between 7 AM-7:30 AM such that the user gets the required information about the vehicle without any delay. On the other hand, if the vehicle user does not initiate any communication at a particular time, for example, 10 PM to 3 AM, the cloud server determines that there is no interaction during that time period and may connect the vehicle to the vehicle app every 20-30 minutes between 10 PM to 3 AM. Similarly, when the vehicle is getting charged at a public charging station, the vehicle user may likely interact more with the app as compared to when the vehicle is getting charged at the vehicle user's home. Accordingly, the connection or the communication cycle between the vehicle, vehicle app, and cloud is modified.

In some embodiments, vehicle user 106 may be associated with multiple vehicles and the user equipment may include the apps associated with each of the vehicles. The communication cycle between the vehicle and its respective vehicle app is then adjusted based on how the user interacts with that vehicle.

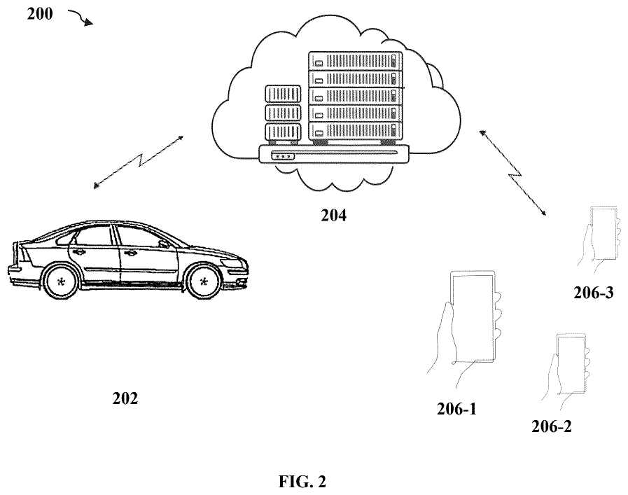

FIG. 2 illustrates a network diagram associated with multiple vehicle users according to an embodiment.

Referring to FIG. 2, network 200 comprises vehicle 202 associated with multiple vehicle users 206-1, 206-2, 206-3. Each of the users may communicate with vehicle 202 through cloud server 204. Cloud server 204 may detect patterns associated with the usage of the vehicle app with each of the users and modify the communication cycle between the vehicle and vehicle app based on which user is currently using the vehicle. For example, vehicle user 206-1 may interact with the vehicle in the morning times and vehicle user 206-3 may interact with the vehicle more during the evening times and therefore when vehicle user 206-1 is using the vehicle, the system increases the frequency of connection between the vehicle and the vehicle app during morning times and similarly when vehicle user 206-3 is using the vehicle the system increases the frequency of connection between the vehicle and the vehicle app in the evening times.

In some embodiments, a system may be associated with at least one of the vehicle, cloud server, a centralized server, a server associated with each of the user equipment associated with each of the users. The system may implement a method for adaptively adjusting communication cycles between the vehicle, vehicle app, and cloud server when multiple users are associated with the vehicle comprising: obtaining a number of vehicle users associated with a vehicle; obtaining a first information associated with user behavior for each of the vehicle users; obtaining a second information associated with at least one of location of the vehicle, vehicle status, and weather conditions; detecting patterns associated with usage of a vehicle app for each of the vehicle users based on the first information and the second information; and modifying frequency of communication between the vehicle, the vehicle app, and a cloud server based on the detected patterns.

In some embodiments, the method may further comprise: determining, for each of the vehicle users, a frequency of interaction with the vehicle app based on at least one of: a time period during a day, the location of the vehicle, and the vehicle status; and obtaining the user behavior for each of the vehicle users based on the determination.

In some embodiments, the first information comprises user behavior for each of the users as logged by the app installed in the user equipment corresponding to each of the users and the second information comprises vehicle status, weather conditions, and location of the vehicle.

In some embodiments, when one or more users are associated with the vehicle the application may be installed in the user equipment associated with each of the users based on an authorization or permission from a primary user, the primary user being the user with whose name the vehicle is registered with a transport governing body.

In some embodiments, the vehicle app may be installed in user equipment associated with more than one vehicle user, wherein a first vehicle user may transfer one or more information from the vehicle app installed in a first user equipment associated with the first user to the vehicle app installed in a second user equipment associated with a second user.

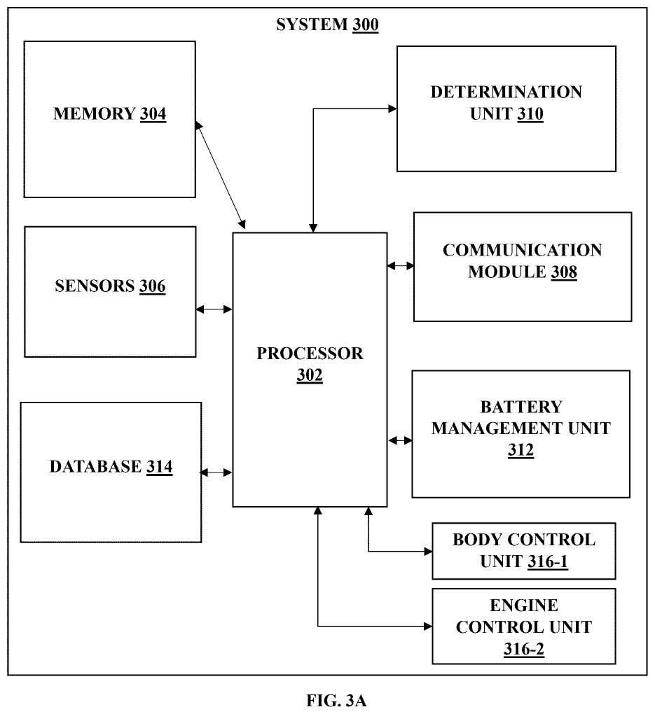

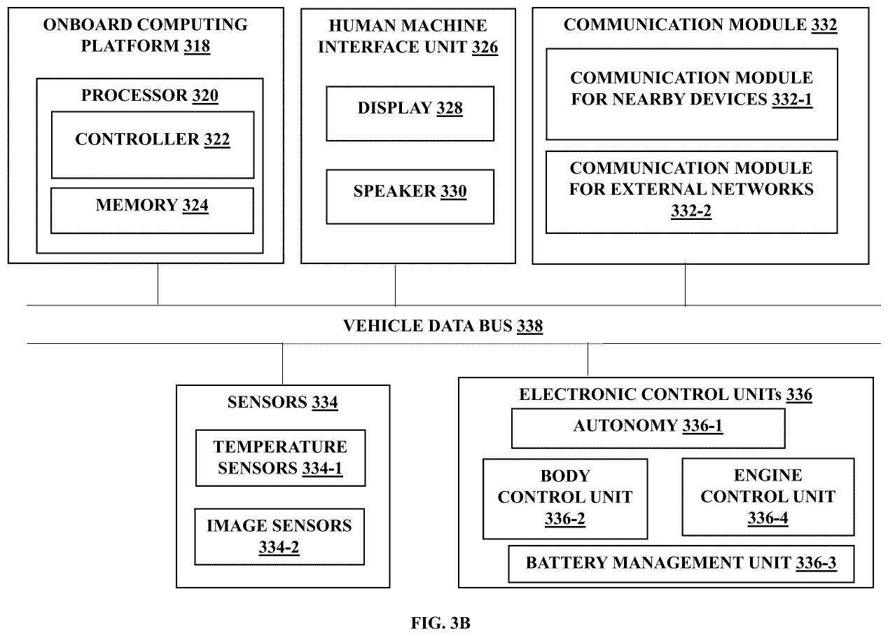

FIG. 3A illustrates a block diagram of a system associated with a vehicle according to an embodiment.

System 300 comprises processor 302, memory 304, sensors 306, communication module 308, determination unit 310, battery management unit 312, database 314, body control unit 316-1, and engine control unit 316-2.

Referring to FIG. 3A, processor 302 may be a high-performance, multi-core CPU or system-on-chip (SoC) solution to process vast amounts of data. In some embodiments, processor 302 is communicatively coupled to sensors 306, battery management unit 312, body control unit 316-1, and engine control unit 316-2 to obtain information associated with temperature status, connection status, running status, lock status, and ignition status of the vehicle. In some embodiments, determination unit 310 may determine the frequency with which information from battery management unit 312, body control unit 316-1, and engine control unit 316-2 is accessed and accordingly adjust the communication between the vehicle and the cloud server to transfer the required information.

Processor 302 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processors depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, determine conditions associated with the vehicle and a user of the vehicle, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. Processor 302 interacts and exchanges data with one or more of the other components or modules of the system, for example, memory 304, sensors 306, communication module 308, determination unit 310, battery management unit 312, database 314, body control unit 316-1, and engine control unit 316-2.

Referring to FIG. 3A, memory 304 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 3A, sensors 306 may comprise various sensors such as a temperature sensor, ultrasonic sensors, LIDAR sensors, radar sensors, camera-based sensors, Infrared (IR) sensors, radio frequency identification (RFID) sensors, etc. Sensors, for example, cameras, LIDARs, radars, and ultrasonic sensors, enable autonomous vehicles to detect and recognize objects, obstacles, and pedestrians on the road to enable navigation of the autonomous vehicles. In some embodiments, communication module 308 facilitates communication between different modules within system 300, e.g., communication between the vehicle and other devices, other vehicles, and other infrastructure components or energy source, for example, grid, charging points, cloud servers, etc.

Referring to FIG. 3A, in some embodiments, database 314 may store data associated with various sensors 306, determination unit 310, and battery management unit 312. In some embodiments, database 314 may be locally present in system 300 or may be present in a server associated with a manufacturer of the vehicle or in a cloud server. Processor 302 may fetch the data from the database to obtain user behavior information. The user behavior information is associated with the vehicle user's app usage pattern, i.e., how frequently the vehicle user interacts with the vehicle app to access information from the vehicle. In some embodiments, the user behavior information may be obtained by collecting previous app usage information and storing it in the database.

Referring to FIG. 3A, communication module 308, determination unit 310, and battery management unit 312 are coupled to processor 302. Communication module 308 is operable to communicate with external devices and infrastructure devices. In some embodiments, the communication module transmits information associated with information associated with temperature status, connection status, running status, lock status, and ignition status of the vehicle to the cloud server.

In some embodiments, battery management unit 312, body control unit 316-1, engine control unit 316-2, database 314, sensors 306, and determination unit 310 are communicatively coupled to processor 302. Battery management unit 312 provides a connection status of the battery associated with the vehicle, and the processor may determine whether the vehicle is connected with a charging station or not, and in case the vehicle is connected, determine if the vehicle is charging from the charging station or discharging to the charging station. Body control unit 316-1 provides information associated with vehicle lock and ignition, the determination unit may determine whether the vehicle is in locked condition or unlocked condition based on the information. Further, the determination unit 310 may determine whether vehicle ignition is ON, vehicle ignition is OFF, a first time duration associated with the vehicle ignition being ON, and a second time duration associated with the vehicle ignition being OFF based on information associated with the ignition. In some embodiments, the engine control unit provides information associated with the engine, and the determination unit 310 may determine whether the vehicle is in parked state or running state. Determination unit 310 may send one or more of the determinations to the processor, wherein the processor may, based on the determinations and information from sensors 306 and database 314, modify the communication cycles between the vehicle, vehicle app, and the cloud.

FIG. 3B illustrates a block diagram of electronic components of the vehicle according to an embodiment.

Referring to FIG. 3B, the vehicle comprising various electronic components, such as, on-board computing platform 318, human-machine interface (HMI) unit 326, communication module 332, sensors 334, electronic control units (ECUs) 336, and vehicle data bus 338, is shown. FIG. 3B illustrates an example architecture of some of the electronic components, as shown in FIG. 3A. On-board computing platform 318 comprises processor 320 (also referred to as a microcontroller unit or a controller) and memory 324. In the illustrated example, processor 320 of the on-board computing platform is structured to comprise controller 322. In other examples, controller 322 is incorporated into another ECU with its own processor and memory. The processor may be any suitable processing device or set of processing devices such as, but not limited to, a microprocessor, a microcontroller-based platform, an integrated circuit, one or more field-programmable gate arrays (FPGAs), and/or one or more application-specific integrated circuits (ASICs). The memory may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid-state drives, etc.). In some examples, memory 324 comprises multiple kinds of memory, particularly volatile memory, and non-volatile memory. Memory 324 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 324, the computer-readable medium, and/or within processor 320 during execution of the instructions.

HMI unit 326 provides an interface between the vehicle and a user. HMI unit 326 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 328 (e.g., a heads-up display, a center console display such as a liquid crystal display (LCD), an organic light emitting diode (OLED) display, a flat panel display, a solid-state display, etc.), and/or speaker 330. For example, the display, the speaker, and/or other input and output device(s) of HMI unit 326 are operable to emit an alert, such as an alert to request manual takeover to an operator (e.g., a driver) of the vehicle. Further, the HMI unit of the illustrated example comprises hardware (e.g., a processor or controller, memory, storage, etc.) and software (e.g., an operating system, etc.) for an infotainment system that is presented via display 328.

Sensors 334 are arranged in and/or around the vehicle to monitor the interior regions of the vehicle and/or an environment in which the vehicle is driving. One or more of the sensors may be mounted to measure various parameters around an exterior of the vehicle. Additionally, or alternatively, one or more of sensors may be mounted inside a cabin of the vehicle or in a body of the vehicle (e.g., an engine compartment, wheel wells, etc.) to measure properties of the vehicle and/or interior sensing of the vehicle. For example, sensors 334 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. According to an embodiment of the system, the one or more sensors associated with the vehicle comprises camera-based sensors or a camera coupled with a computer vision system.

In some embodiments, sensors 334 comprise temperature sensors 334-1 and image sensors 334-2. Temperature sensors 334-1 may be placed around an exterior of the vehicle to determine the temperature in the surroundings of the vehicle and inside the vehicle to detect the cabin temperature. Image sensors 334-2 comprise a camera or a video camera capable of capturing the image or video of the vehicle's surroundings. In some embodiments, the captured image or video may be transmitted to the on-board computing platform 318 to determine the location of the vehicle. In some embodiments, the captured image may be transmitted to the cloud server to determine the location of the vehicle.

Referring to FIG. 3B, ECUs 336 monitor and control the subsystems of the vehicle. For example, ECUs 336 are discrete sets of electronics that comprise their own circuit(s) (e.g., integrated circuits, microprocessors, memory, storage, etc.) and firmware, sensors, actuators, and/or mounting hardware. ECUs 336 communicates and exchanges information via vehicle data bus 338. Additionally, the ECUs may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus.

In the illustrated example, ECUs 336 comprise autonomy unit 336-1, body control unit 336-2, engine control unit 336-4 and battery management unit 336-3. For example, autonomy unit 336-1 is operable to perform autonomous and/or semi-autonomous driving maneuvers (e.g., defensive driving maneuvers) of the vehicle based upon, at least in part, instructions received from controller 322 and/or data collected by sensors 334 (e.g., object detection sensors). Further, body control unit 336-2 controls one or more subsystems throughout the vehicle, such as power windows, power locks, an immobilizer system, power mirrors, etc. For example, body control unit 336-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. In some embodiments, body control unit 336-2 provides information about at least one of vehicle lock status and ignition status to the on-board computing platform. In some embodiments, engine control unit 336-4 provides information associated with vehicle running status to the on-board computing platform. For example, battery management unit 336-3 (similar to battery management unit 312 of FIG. 3A) is operable to provide a connection status of the vehicle battery with the charging station.

Referring to FIG. 3B, vehicle data bus 338 communicatively couples communication module 332, on-board computing platform 318, HMI unit 326, sensors 334, and ECUs 336. In some examples, vehicle data bus 338 comprises one or more data buses. Vehicle data bus 338 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

Referring to FIG. 3B, communication module 332 may comprise a near field communication module or a communication module for nearby device 332-1 and far field communication module or communication module for external network 332-2. Communication module for nearby devices 332-1 is operable to communicate with other nearby communication devices. In an example, communication module 332 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, communication module for external networks 332-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, communication module 332-2 is operable to communicate with external networks. For example, communication module 332-2 comprises hardware (e.g., processors, memory, storage, antenna, etc.) and software to control wired or wireless network interfaces. In the illustrated example, the communication module 332-2 comprises one or more communication controllers for wireless networks, satellite communication network, microwave communication network, fiber optic communication network, cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 332-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

Autonomy unit 336-1 of the illustrated example is operable to perform autonomous and/or semi-autonomous driving maneuvers, such as defensive driving maneuvers, for the vehicle. For example, autonomy unit 336-1 performs the autonomous and/or semi-autonomous driving maneuvers based on data collected by sensors 334. In some examples, autonomy unit 336-1 is operable to operate a fully autonomous system, a park-assist system, an advanced driver-assistance system (ADAS), and/or other autonomous system(s) for the vehicle.

Further, in the illustrated example, controller (or control module) 322 is operable to monitor an ambient environment of the vehicle. For example, to enable autonomy unit 336-1 to perform autonomous and/or semi-autonomous driving maneuvers, the controller collects data that is collected by sensors 334 of the vehicle. In some examples, the controller collects location-based data via communication module 332-1 and/or another module (e.g., a GPS receiver) to facilitate the autonomy unit in performing autonomous and/or semi-autonomous driving maneuvers. Additionally, the controller collects data from (i) adjacent vehicle(s) via communication module 332-1 and V2V communication and/or (ii) roadside unit(s) via communication module 332-1 and V2I communication to further facilitate autonomy unit 336-1 in performing autonomous and/or semi-autonomous driving maneuvers.

According to an embodiment, the communication module supports a communication protocol, wherein the communication protocol comprises at least one of an Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

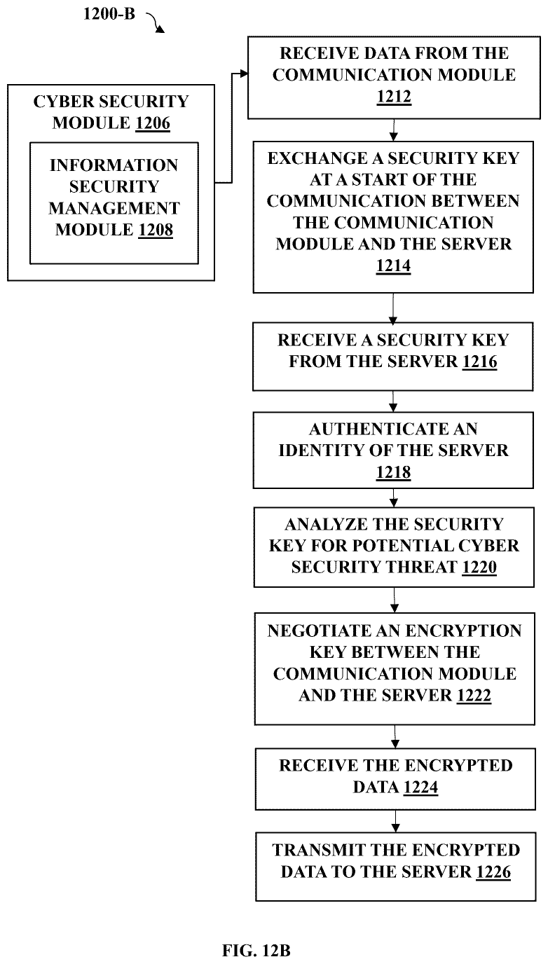

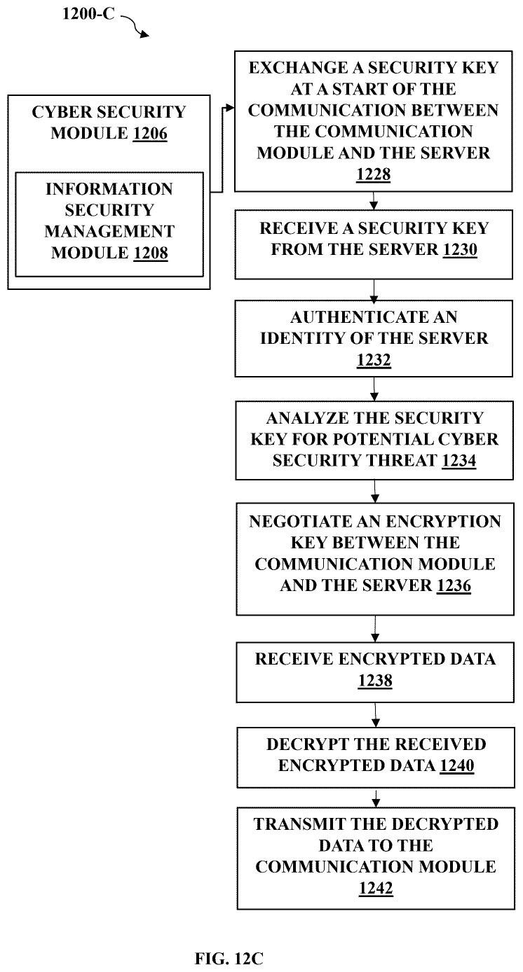

In an embodiment, communication module 332 may comprise cyber security module 1206 (shown in FIG. 12A). In some embodiments, communication module 332 may communicate with cyber security module 1206 to perform secure communication with nearby devices and external networks. In one aspect, a secure communication management (SCMT) computer device for providing secure data connections is provided. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

In some embodiments, communication module 332 may receive one or more information associated with the vehicle status, vehicle location, weather conditions from the one or more ECUs and sensors and may communicate the one or more information to the cloud server.

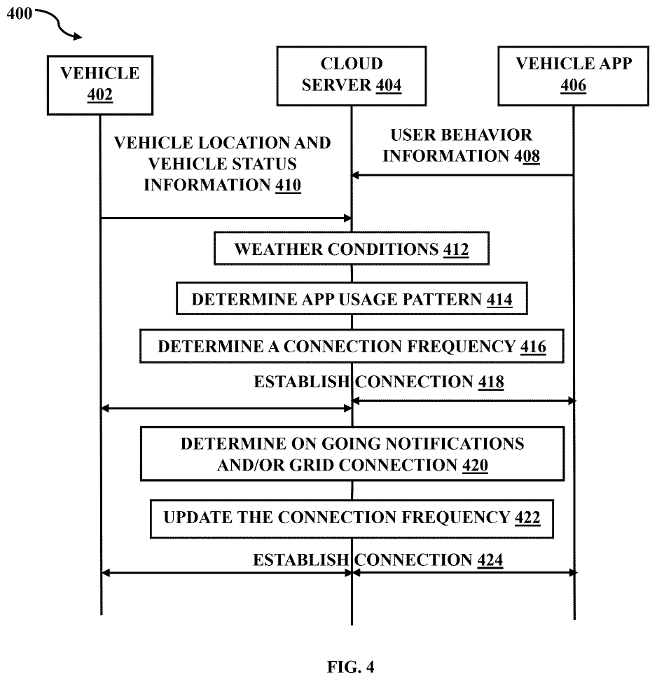

FIG. 4 illustrates message flow diagram 400 between the vehicle, a vehicle app, and a cloud server according to an embodiment.

Referring to FIG. 4, message flow diagram 400 illustrates signals between vehicle 402, cloud server 404, and vehicle app 406. In some embodiments, a user associated with the vehicle may initiate one or more commands from the vehicle app. The vehicle app may be loaded onto a handheld device or user equipment associated with the user. Cloud server 404 may obtain user behavior information 408 from the vehicle app. In some embodiments, user behavior comprises a frequency associated with the vehicle user interacting with the vehicle app based on at least one of: a time period during a day, the location of the vehicle, and the vehicle status, wherein frequency associated with interacting with the vehicle app is determined based on a number of times the vehicle user opens the vehicle app based on at least one of the location of the vehicle, the vehicle status, and during at least one of the first interaction time, the second interaction time, the third interaction time, the fourth interaction time, the fifth interaction time, and the sixth interaction time. According to an embodiment, user behavior information is generated by vehicle app 406, wherein the vehicle app creates a log of how frequently the user interacts with the vehicle app to send requests or commands to vehicle 402. The interaction between vehicle 402 and vehicle app 406 is through cloud server 404. According to an embodiment, the cloud server is associated with the vehicle manufacturer. According to another embodiment, the cloud server is associated with a third-party provider authorized by the vehicle manufacturer. In some embodiments, a centralized server may enable interaction between vehicle 402 and vehicle app 406. The centralized server may be associated with the vehicle manufacturer or a third-party service provider authorized by the manufacturer.

Referring to FIG. 4, vehicle 402 may transmit at least one of vehicle location and vehicle status information 410 to cloud server 404. Further, the cloud server may obtain weather conditions 412 from weather forecast resources. In some embodiments, one or more temperature sensors in the exterior of the vehicle may capture the temperature of the surroundings of the vehicle and transmit the information to the cloud server.

Referring to FIG. 4, cloud server, based on the information from vehicle 402 and vehicle app 406, may determine an app usage pattern 414. The app usage pattern is based on how frequently the user accesses the app in a particular situation. For example, the app usage pattern is how many times the user is accessing the app to check the charging status of the vehicle when the vehicle is getting charged at a public charging station versus how many times the user is accessing the app to check the charging status of the vehicle when the vehicle is getting charged at user's home. In some embodiments, the app usage pattern may assist in predicting a likelihood for interaction between the vehicle, vehicle app, and the cloud server. Accordingly, cloud server 404 may determine a connection frequency 416 between the vehicle and the vehicle app based on the predicted likelihood of interaction and establish a connection 418. For example, if the vehicle is getting charged at a public charging station, then the frequency of the user using the app is more and therefore the cloud server may determine to establish connection between the vehicle and the vehicle app every 2 minutes for updating the charging status such that whenever the user opens the app, the app shows the most recent charging status without much delay. On the other hand, if the vehicle is getting charged at the user's home, then the frequency of the user using the app is less and therefore the cloud server may determine to establish connection between the vehicle and the vehicle app every 30 minutes to update the charging status.

Referring to FIG. 4, in some embodiments, the cloud server determines whether there are any ongoing notifications in the app or if the vehicle is connected to the grid 420, in such situations the vehicle and the app may require a more frequent connection. Cloud server 404 updates the connection frequency 422 and establishes connection between the vehicle and the vehicle app based on the updated frequency 424.

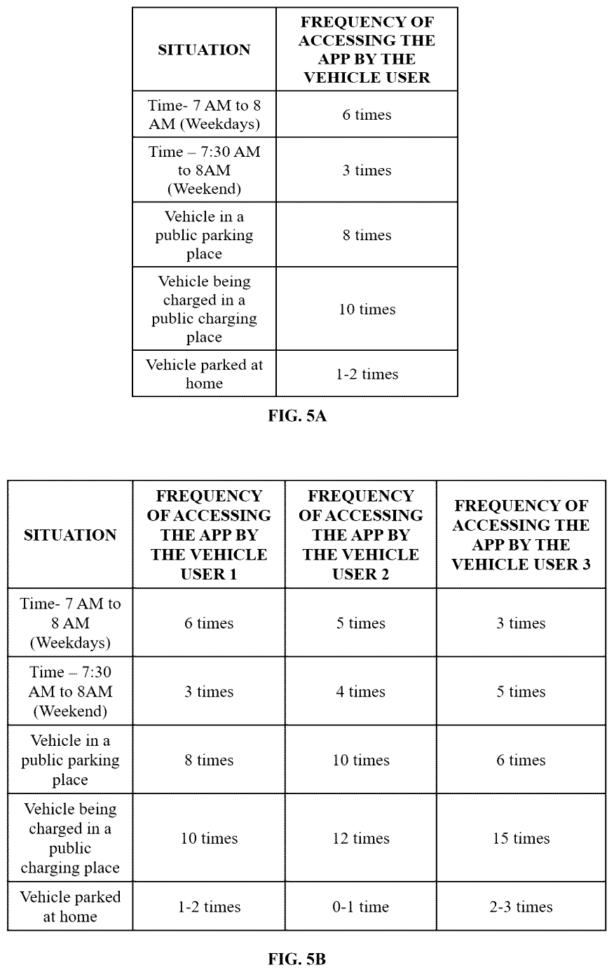

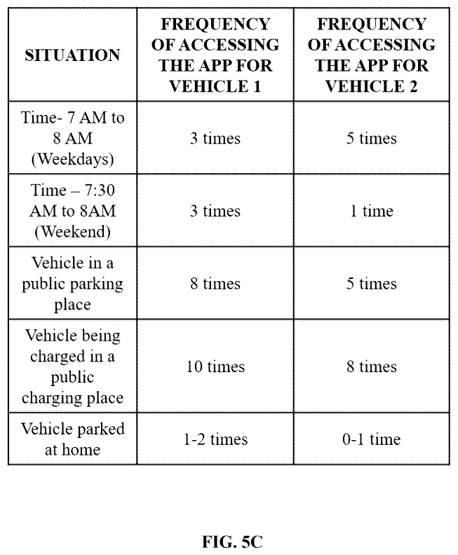

FIG. 5A illustrates user behavior information associated with the single vehicle user according to an embodiment.

Referring to FIG. 5A, an example of logging user behavior associated with a single user associated with a single vehicle is given.

FIG. 5B illustrates user behavior information associated with multiple vehicle users according to an embodiment.

Referring to FIG. 5B, an example of logging user behavior associated with multiple users associated with a single vehicle is given.

FIG. 5C illustrates user behavior information associated with the single vehicle user for multiple vehicles according to an embodiment.

Referring to FIG. 5C, an example of logging user behavior associated with a single user associated with multiple vehicles is given.

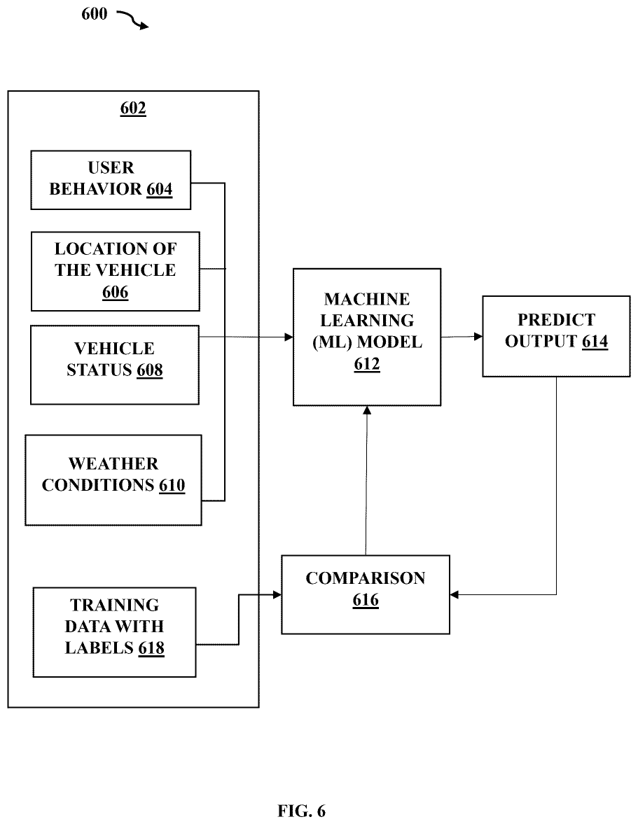

FIG. 6 illustrates block diagram 600 for an Artificial Intelligence and Machine Learning (AI/ML) model used in a system for adaptively adjusting communication cycles between the vehicle, vehicle app, and the cloud server according to an embodiment.

Referring to FIG. 6, the machine learning model 602 may take as input any data associated with user behavior 604, location of the vehicle 606, vehicle status 608, weather conditions 610 and learn to identify features within the data that are predictive of modifying the communication cycle between the vehicle, the vehicle app, and the cloud server. Training data with labels 618 may comprise, for example, a historical data of patterns associated with the usage of the vehicle app by the vehicle user based on a number of times the vehicle user opens the vehicle app based on at least one of the location of the vehicle, the vehicle status, and during at least one of the first time of interaction, the second time of interaction, the third time of interaction, the fourth time of interaction, the fifth time of interaction, and the sixth time of interaction.

In an embodiment, during training, machine learning model 612 may process the training data sample (e.g., user behavior 604, location of the vehicle 606, vehicle status 608, weather conditions 610), and, based on the current parameters of machine learning model 612, predict output 614 which may be a likelihood of interaction between the vehicle, the vehicle app, and the cloud. In an embodiment, the real-time sensor data may be processed using one or more machine learning models 612, trained based on similar types of data to correctly select the frequency for communication. For example, comparison 616 may be based on a loss function that measures a difference between the predicted/detected output and training data with labels 618. Based on the comparison 616 or the corresponding output of the loss function, a training algorithm may update the parameters of machine learning model 612 with the objective of minimizing the differences or loss between subsequent predicted output 614 and corresponding labels 618. By iteratively training in this manner, machine learning model 612 may “learn” from the different training data samples and become better at predicting output 614. In an embodiment, machine learning model 612 is trained using data which is specific to a vehicle user and a vehicle model at different situations for predicting adjustments to the communication cycles to provide an optimal connection frequency between the vehicle, the vehicle app, and the cloud server such that waiting time for the vehicle user is reduced and at the same time energy of the vehicle battery and data of the user equipment is saved. In an embodiment, the pattern associated with the usage of the vehicle app may be detected based on the inputs, and the detected pattern may be given weights and provided as an input to the AI/ML system.

Through training, machine learning model 612 may learn to identify predictive and non-predictive features and apply the appropriate weights to the features to optimize detecting and predictive accuracy of machine learning model 612. In embodiments where supervised learning is used and each training data sample has a label, the training algorithm may iteratively process each training data sample and generate a predicted output 614. Any suitable machine learning model and training algorithm may be used, including, e.g., neural networks, decision trees, clustering algorithms, and any other suitable machine learning techniques. Once trained, machine learning model 612 may take input data and predict a likelihood for interaction between the vehicle app, the vehicle, and the cloud server based on the detected patterns. Further, the frequency of the communication between the vehicle, the vehicle app and the cloud server may be modified based on the prediction. In an embodiment, machine learning model 612 is an artificial neural networks (ANN) model.

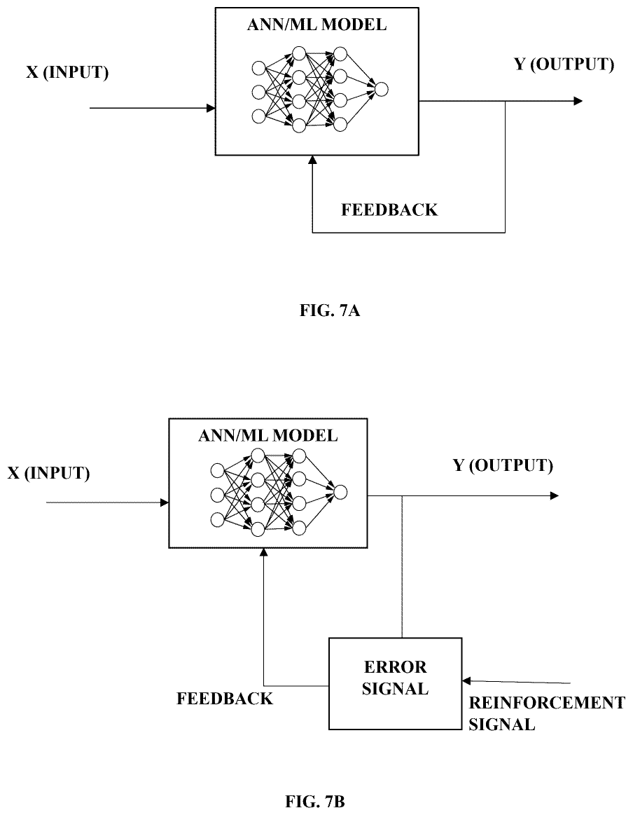

FIG. 7A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises data associated with user behavior 604, location of the vehicle 606, vehicle status 608, and weather conditions 610. The machine learning or the ANN model is trained using the input data to predict a likelihood of interaction between the vehicle, vehicle app, and the cloud server based on the input data, and obtain the response or output as a communication cycle between the vehicle, the vehicle app, and the cloud server based on the prediction, wherein the communication cycle is chosen to reduce waiting time of the user and at the same time save battery and data. The model may learn from the input data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an a priori algorithm.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the model's performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of objects, different users interacting with different objects, tracking frequency, monitoring frequency etc.) are used that are meant for the model to learn how and what adjustments need to be performed. Afterward, the model is tested using unlabeled data. By using, for example, deep learning and neural networks, the model can then make predictions on whether the desired output (for e.g., recognition of objects and the corresponding confidence score, dynamic tracking of the object and recording last known position, a prediction of objects that the user might likely be forgetting, and the locations within the vehicle where objects when placed may be likely forgotten etc.) is in the predicted accuracy level. However, in cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically. These models may be utilized at various levels, for example, (i) prediction of the likelihood of interaction between the vehicle, vehicle app, and the cloud server and (ii) selection of an optimal communication cycle.

FIG. 7B shows the structure of the neural network/machine learning model with reinforcement learning according to an embodiment. The network receives feedback from authorized networked environments. Though the feedback logic is similar to supervised learning, the feedback obtained in this case is evaluative, not instructive, which means there is no teacher as in supervised learning. After receiving feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, the machine learning model is configured to learn using labeled data using a supervised learning method, wherein the supervised learning method comprises logic using at least one of a decision tree, a logistic regression, a support vector machine, a k-nearest neighbors, a Naïve Bayes, a random forest, a linear regression, a polynomial regression, and a support vector machine for regression.

In an embodiment, the machine learning model is configured to learn from the real-time data using an unsupervised learning method, wherein the unsupervised learning method comprises logic using at least one of a k-means clustering, a hierarchical clustering, a hidden Markov model, and an a priori algorithm.

In an embodiment, the machine learning model has a feedback loop, wherein the output from a previous step is fed back to the model in real-time to improve the performance and accuracy of the output of a next step.

In an embodiment, the machine learning model comprises a recurrent neural network model.

In an embodiment, the machine learning model has a feedback loop, wherein the learning is further reinforced with a reward for each true positive of the output of the system.

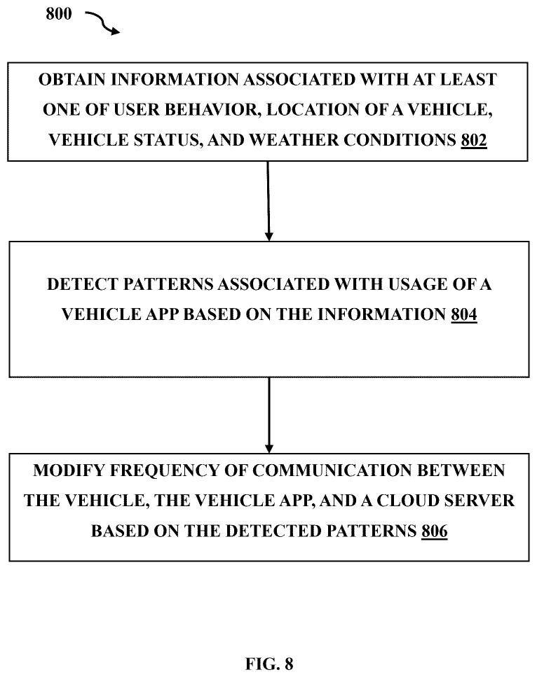

FIG. 8 illustrates a flow chart describing a method for adaptively adjusting communication cycles between the vehicle, vehicle app, and the cloud server according to an embodiment.

Referring to FIG. 8, method 800 comprises, obtaining information associated with at least one of user behavior, location of a vehicle, vehicle status, and weather conditions at step 802. Further, method 800 comprises detecting patterns associated with usage of a vehicle app based on the information at step 804, and modifying frequency of communication between the vehicle, the vehicle app, and a cloud server based on the detected patterns at step 806.

In some embodiments, method 800 further comprises predicting a likelihood for interaction between the vehicle, the vehicle app, and the cloud server based on the detected patterns; and modifying the frequency of the communication between the vehicle, the vehicle app, and the cloud server based on the prediction.

In some embodiments, method 800 further comprises determining presence of at least one of ongoing notifications in the vehicle app and a connection between the vehicle and a grid; and updating the prediction based on the presence of at least one of the ongoing notifications in the vehicle app and the connection between the vehicle and the grid.

In some embodiments, method 800 further comprises obtaining the user behavior based on at least one of: a time associated with the usage of the vehicle app by a vehicle user and a frequency associated with opening the vehicle app by the vehicle user, wherein the time associated with the usage of the vehicle app comprises at least one of: a first time of interaction between the vehicle user and the vehicle app on week days, a second time of interaction between the vehicle user and the vehicle app on weekends, a third time of interaction between the vehicle user and the vehicle app on national holidays, and a fourth time of interaction between the vehicle user and the vehicle app on days with disrupting events.

In some embodiments, the frequency associated with interacting with the vehicle app is determined based on a number of times the vehicle user opens the vehicle app based on at least one of the location of the vehicle, the vehicle status, and during at least one of the first time of interaction, the second time of interaction, the third time of interaction, the fourth time of interaction, the fifth time of interaction, and the sixth time of interaction.

In some embodiments, the location of the vehicle comprises at least one of: a parking place of the vehicle and a charging place of the vehicle.

In some embodiments, method 800 further comprises determining the vehicle to be in at least one of: the parking place and the charging place based on at least one of input from a vehicle user in the vehicle app, detecting presence of a connection between the vehicle and a charging station, a geographical location of the vehicle based on global positioning system (GPS) coordinates, and one or more images of surroundings of the vehicle.

In some embodiments, method 800 further comprises capturing the one or more images of the surroundings of the vehicle using one or more sensors in the vehicle; and transmitting the captured one or more images to the vehicle app to determine the location of the vehicle. In some embodiments, the captured images may be transmitted to the cloud server for determining the location of the vehicle. In some embodiments, system 300 may determine the location of the vehicle based on the captured images.

In some embodiments, the parking place of the vehicle comprises at least one of a private parking place and a public parking place and the charging place of the vehicle comprises a public charging place and a private charging place.

In some embodiments, the vehicle status comprises at least one of: running status, connection status, ignition status, lock status, and temperature status.

In some embodiments, the running status comprises at least one of: the vehicle in a parked state and in a moving state, wherein the method further comprises determining the running status of the vehicle based on information from an engine control unit.

In some embodiments, the connection status comprises at least one of: the vehicle connected with a charging station for a charging operation, the vehicle connected with the charging station for a discharging operation, and the vehicle being disconnected from the charging station, wherein the method further comprises: detecting the connection status based on information from a battery management unit (BMU) of the vehicle.

In some embodiments, the ignition status comprises at least one of: vehicle ignition ON, vehicle ignition OFF, a first time duration associated with the vehicle ignition being ON, and a second time duration associated with the vehicle ignition being OFF, wherein the method further comprises: determining the ignition status based on information from the BCM of the vehicle.

In some embodiments, the lock status comprises at least one of: the vehicle being locked and the vehicle being unlocked, wherein the method comprises: determining the lock status based on information from the BCM of the vehicle.

In some embodiments, the temperature status comprises at least one of: cabin temperature of the vehicle and a preset temperature in the vehicle, wherein the method comprises: determining the temperature status of the vehicle based on information from one or more temperature sensors associated with the vehicle.

In some embodiments, the weather conditions comprise at least one of: weather forecast and weather conditions surrounding the vehicle.

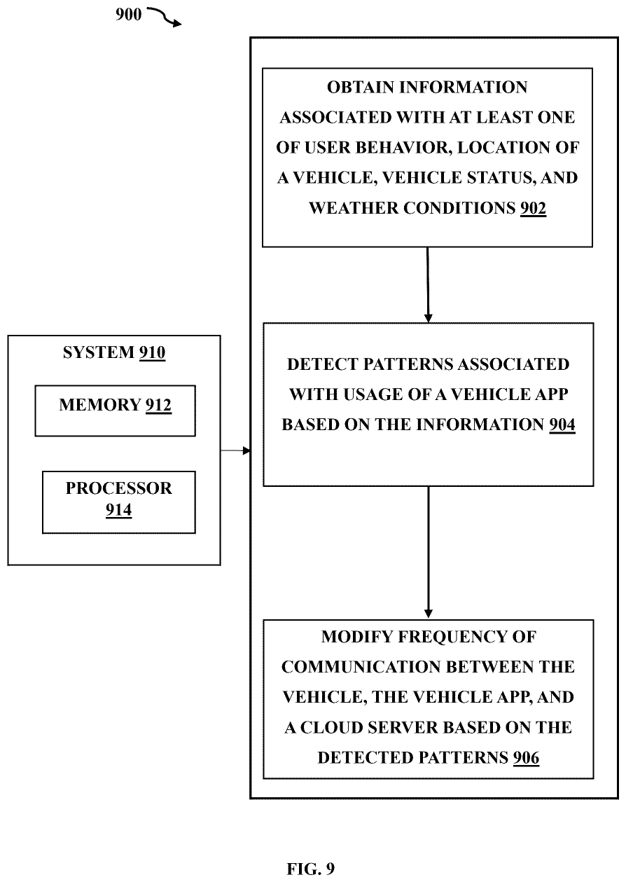

FIG. 9 illustrates block diagram 900 of the system implementing the method for adaptively adjusting communication cycles between the vehicle, vehicle app, and the cloud server according to an embodiment.

According to an embodiment, disclosed is system 910 comprising processor 914; and memory 912, wherein memory 912 storing processor-executable instructions, which on execution, causes the processor to: obtain information associated with at least one of user behavior, location of a vehicle, vehicle status, and weather conditions at step 902, detect patterns associated with usage of a vehicle app based on the information at step 904, and modify frequency of communication between the vehicle, the vehicle app, and a cloud server based on the detected patterns at step 906.

In some embodiments, the processor-executable instructions, which on execution, further cause processor 914 to: predict a likelihood for interaction between the vehicle app, the vehicle, and the cloud server based on the detected patterns; and modify the frequency of the communication between the vehicle, the vehicle app and the cloud server based on the prediction.

In some embodiments, the processor-executable instructions, which on execution, further cause processor 914 to: determine presence of at least one of ongoing notifications in the vehicle app and a connection between the vehicle and a grid; and update the prediction based on the presence of at least one of the ongoing notifications in the vehicle app and the connection between the vehicle and the grid.

According to an embodiment, system 910 is associated with at least one of: the cloud server, vehicle, user equipment associated with the vehicle user, a centralized server associated with at least one of a manufacturer of the vehicle and a manufacturer of the user equipment associated with the vehicle user, and a third-party server authorized by the manufacturer of the vehicle.

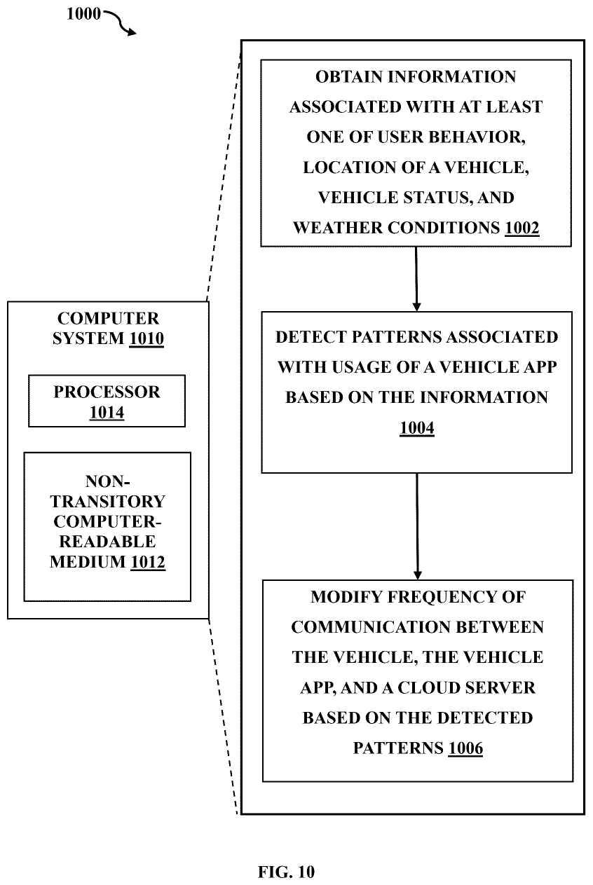

FIG. 10 illustrates block diagram 1000 of the method executed by the non-transitory computer-readable medium for adaptively adjusting communication cycles between the vehicle, vehicle app, and the cloud server according to an embodiment.

According to an embodiment, disclosed is computer system 1010 non-transitory computer-readable medium 1012 having stored thereon instructions executable by processor 1014 to perform operations comprising: obtaining information associated with at least one of user behavior, location of a vehicle, vehicle status, and weather conditions at step 1002, detecting patterns associated with usage of a vehicle app based on the information at step 1004, and modifying frequency of communication between the vehicle, the vehicle app, and a cloud server based on the detected patterns at step 1006.

In some embodiments, non-transitory computer-readable medium 1012 further comprises instructions to perform operations comprising: predicting a likelihood for interaction between the vehicle, the vehicle app, and the cloud server based on the detected patterns; and modifying the frequency of the communication between the vehicle, the vehicle app, and the cloud server based on the prediction.

In some embodiments, non-transitory computer-readable medium 1012 further comprises instructions to perform operations comprising: determining presence of at least one of ongoing notifications in the vehicle app and a connection between the vehicle and a grid; and updating the prediction based on the presence of at least one of the ongoing notifications in the vehicle app and the connection between the vehicle and the grid.

In some embodiments, non-transitory computer-readable medium 1012 further comprises instructions to perform operations comprising: determining the vehicle to be in at least one of: the parking place and the charging place based on at least one of input from a vehicle user in the vehicle app, detecting presence of a connection between the vehicle and a charging station, a geographical location of the vehicle based on global positioning system (GPS) coordinates, and one or more images of surroundings of the vehicle.

In some embodiments, non-transitory computer-readable medium 1012 further comprises instructions to perform operations comprising: capturing the one or more images of the surroundings of the vehicle using one or more sensors in the vehicle; and transmitting the captured one or more images to the vehicle app to determine the location of the vehicle.

In some embodiments, non-transitory computer-readable medium 1012 further comprises instructions to perform operations comprising: determining the running status of the vehicle based on information from an engine control unit.

In some embodiments, non-transitory computer-readable medium 1012 further comprises instructions to perform operations comprising: detecting the connection status based on information from the battery management unit of the vehicle.

In some embodiments, non-transitory computer-readable medium 1012 further comprises instructions to perform operations comprising: determining the ignition status based on information from the BCM of the vehicle.

In some embodiments, non-transitory computer-readable medium 1012 further comprises instructions to perform operations comprising: determining the lock status based on information from the BCM of the vehicle.

In some embodiments, non-transitory computer-readable medium 1012 further comprises instructions to perform operations comprising: determining the temperature status of the vehicle based on information from one or more temperature sensors associated with the vehicle.

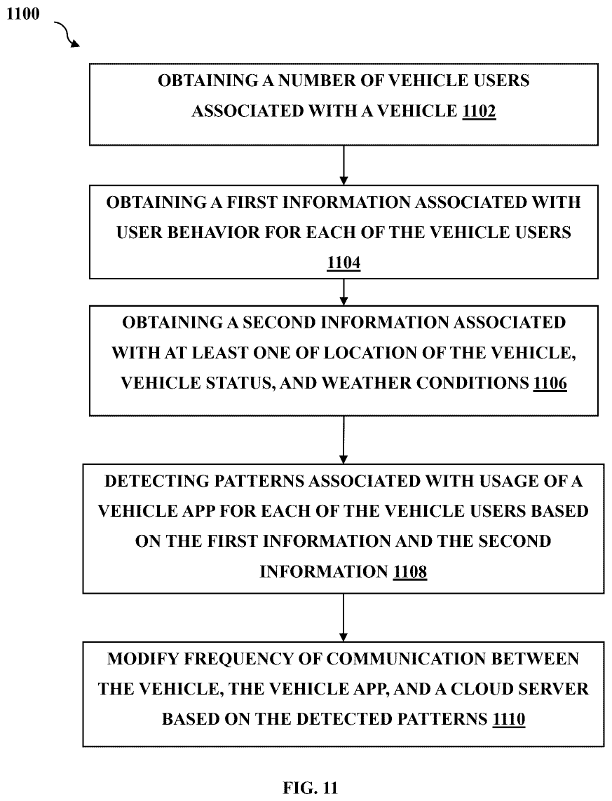

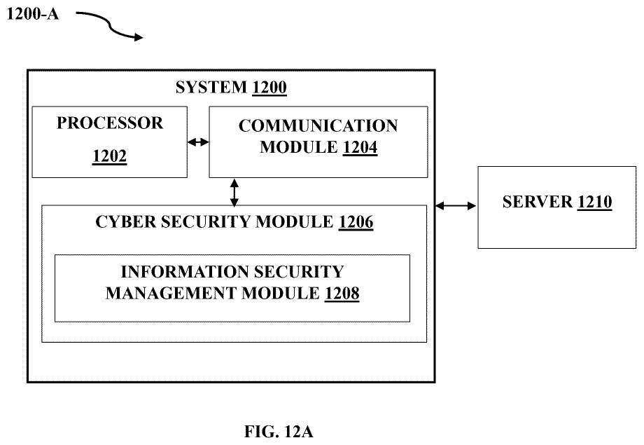

FIG. 11 illustrates a flow chart describing a method for adaptively adjusting communication cycles between the vehicle, vehicle app, and the cloud server for multiple vehicle users according to an embodiment.

Referring to FIG. 11, method 1100 comprises: obtaining a number of vehicle users associated with a vehicle at step 1102; obtaining a first information associated with user behavior for each of the vehicle users at step 1104; obtaining a second information associated with at least one of location of the vehicle, vehicle status, and weather conditions at step 1106; detecting patterns associated with usage of a vehicle app for each of the vehicle users based on the first information and the second information 1108; and modifying frequency of communication between the vehicle, the vehicle app, and a cloud server based on the detected patterns at step 1110.

In some embodiments, method 1100 further comprises: determining, for each of the vehicle user, a frequency of interaction with the vehicle app based on at least one of: a time period during a day, the location of the vehicle, and the vehicle status; and obtaining the user behavior for each of the vehicle users based on the determination.

FIG. 12A shows block diagram 1200-A of a cyber security module in view of the system and server according to an embodiment.

Referring to FIG. 12A, system 1200 comprising processor 1202, communication module 1204, cyber security module 1206, and information security management module 1208 in communication with server 1210, is shown. The communication of data between system 1200 and server 1210 through communication module 1204 is first verified by information security management module 1208 before being transmitted from system 1200 to server 1210 or from server 1210 to system 1200. Information security management module 1208 is operable to analyze the data for potential cyber security threats, to encrypt the data when no cyber security threat is detected, and to transmit the data encrypted to system 1200 or server 1210.

FIG. 12B shows an embodiment of the cyber security module, in accordance with some embodiments of the present disclosure.

Referring to FIG. 12B, method 1200-B for securing the data through cyber security module 1206 is shown. At step 1212, the information security management module is operable to receive data from the communication module. At step 1214, the information security management module exchanges a security key at a start of the communication between the communication module and the server. At step 1216, the information security management module receives a security key from the server. At step 1218, the information security management module authenticates an identity of the server by verifying the security key. At step 1220, the information security management module analyzes the security key for potential cyber security threats. At step 1222, the information security management module negotiates an encryption key between the communication module and the server. At step 1224, the information security management module receives the encrypted data. At step 1226, the information security management module transmits the encrypted data to the server when no cyber security threat is detected.

FIG. 12C shows another embodiment of the cyber security module, in accordance with some embodiments of the present disclosure.

Referring to FIG. 12C, method 1200-C for securing the data through the cyber security module is shown. At step 1228, the information security management module is operable to: exchange a security key at a start of the communication between the communication module and the server. At step 1230, the information security management module receives a security key from the server. At step 1232, the information security management module authenticates an identity of the server by verifying the security key. At step 1234, the information security management module analyzes the security key for potential cyber security threats. At step 1236, the information security management module negotiates an encryption key between the communication module and the server. At step 1238, the information security management module receives encrypted data. At step 1240, information security management module 1208 decrypts the encrypted data, and performs an integrity check of the decrypted data. At step 1242, information security management module 1208 transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 12A, identity authentication is first carried out on the system and then on the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting a Rivest-Shamir-Adleman (RSA) encryption algorithm. RSA is a public key cryptosystem that is widely used for secure data transmission. The negotiated keys include a data encryption key and a data integrity check key. In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

In some embodiments, the exchange of information between vehicle 402, cloud server 404, and vehicle app 406 as shown in FIG. 4 may be secured by the cyber security module. Vehicle 402 may include the communication module coupled to the information security management module. Vehicle status information and vehicle location information may be sent to the cloud server through the communication module. In some embodiments, data associated with one or more sensors (e.g. temperature sensor, image sensor) may also be sent to the cloud server. Vehicle status information, location information, and sensor data may be verified by the information security management module before being transmitted from the vehicle to the cloud server. The information security management module is operable to analyze the data for potential cyber security threats, to encrypt the data when no cyber security threat is detected, and to transmit the data encrypted to the cloud server.

How Technical Solution is a Technological Advancement: Currently the vehicle and vehicle app have fixed communication cycles, i.e., they communicate on fixed time intervals to update the vehicle information in the vehicle app. A fixed communication cycle has a few disadvantages. In some situations, the vehicle information in the app is past information, i.e., when the vehicle user wants the current vehicle information, the vehicle user receives information that was a few minutes back. In some situations, the vehicle information is updated even when not in need, i.e., during sleep hours the vehicle user may not check the vehicle information, but due to the fixed time update, the vehicle and the vehicle app may be communicating with the cloud, losing a certain amount of vehicle battery charge and data of the user equipment within the vehicle app. However, in the present disclosure, by adapting the communication cycles based on the user behavior, vehicle location, vehicle status, and weather conditions, a smart system for connecting the vehicle, vehicle app, and the cloud is formed. The solution proposed by the present disclosure enables conserving battery and data and, at the same time, giving the most current vehicle information to the vehicle user whenever asked for it.

Other specific forms may embody the present disclosure without departing from its spirit or characteristics. The embodiments described are in all respects illustrative and not restrictive. Therefore, the appended claims rather than the description herein indicate the scope of the disclosure. All variations which come within the meaning and range of equivalency of the claims are within their scope.

1-68. (canceled)

69. A system comprising:
a memory storing program instructions; and
a processor coupled to the memory and executing the program instructions stored in the memory, wherein the program instructions, when executed by the processor, causes the processor to:
obtain information associated with at least one of user behavior, location of a vehicle, vehicle status, and weather conditions;
detect patterns associated with usage of a vehicle app based on the information; and
modify frequency of communication between the vehicle, the vehicle app, and a cloud server based on the detected patterns.

70. The system of claim 69, wherein the program instructions, when executed by the processor, further causes the processor to:
predict a likelihood for interaction between the vehicle app, the vehicle, and the cloud server based on the detected patterns; and
modify the frequency of communication between the vehicle, the vehicle app and the cloud server based on the prediction.

71. The system of claim 70, wherein the program instructions, when executed by the processor, further causes the processor to:
determine presence of at least one of ongoing notifications in the vehicle app and a connection between the vehicle and a grid; and
update the prediction based on the presence of at least one of the ongoing notifications in the vehicle app and the connection between the vehicle and the grid.

72. The system of claim 69, wherein the user behavior comprises a frequency associated with interacting with the vehicle app based on at least one of: a time period during a day, the location of the vehicle, and the vehicle status.

73. The system of claim 72, wherein the time period during the day comprises at least one of: a first time of interaction between a vehicle user and the vehicle app on week days, a second time of interaction between the vehicle user and the vehicle app on weekends, a third time of interaction between the vehicle user and the vehicle app on national holidays, a fourth time of interaction between the vehicle user and the vehicle app on days with disrupting events, a fifth time of interaction between the vehicle user and the vehicle app during peak hours, and a sixth time of interaction between the vehicle user and the vehicle app during off-peak hours.

74. The system of claim 73, wherein the disrupting events comprises at least one of: an unexpected weather condition, a health emergency of the vehicle user, an accident associated with the vehicle, and a break down condition of the vehicle.

75. The system of claim 73, wherein the frequency associated with interacting with the vehicle app is determined based on a number of times the vehicle user opens the vehicle app based on at least one of the location of the vehicle, the vehicle status, and during at least one of the first time of interaction, the second time of interaction, the third time of interaction, the fourth time of interaction, the fifth time of interaction, and the sixth time of interaction.

76. The system of claim 69, wherein the location of the vehicle comprises at least one of: a parking place of the vehicle and a charging place of the vehicle, wherein the parking place of the vehicle comprises at least one of a private parking place and a public parking place, wherein the charging place of the vehicle comprises a public charging place and a private charging place.

77. The system of claim 69, wherein the vehicle status comprises at least one of: running status, connection status, ignition status, lock status, and temperature status.

78. The system of claim 77, wherein
the running status comprises at least one of: the vehicle in a parked state and in a moving state;
the connection status comprises at least one of: the vehicle connected with a charging station for a charging operation, connected with the charging station for a discharging operation, and disconnected from the charging station;
the ignition status comprises at least one of: vehicle ignition ON, vehicle ignition OFF, a first time duration associated with the vehicle ignition being ON, and a second time duration associated with the vehicle ignition being OFF;
the lock status comprises at least one of: the vehicle being locked and the vehicle being unlocked; and
the temperature status comprises at least one of: cabin temperature of the vehicle and a preset temperature in the vehicle.

79. The system of claim 69, wherein the weather condition comprises at least one of:
weather forecast and weather conditions surrounding the vehicle.

80. A method comprising:
obtaining information associated with at least one of user behavior, location of a vehicle, vehicle status, and weather conditions;
detecting patterns associated with usage of a vehicle app based on the information; and
modifying frequency of communication between the vehicle, the vehicle app, and a cloud server based on the detected patterns.

81. The method of claim 80, further comprising:
predicting a likelihood for interaction between the vehicle, the vehicle app, and the cloud server based on the detected patterns; and
modifying the frequency of the communication between the vehicle, the vehicle app, and the cloud server based on the prediction.

82. The method of claim 81 further comprising:
determining presence of at least one of ongoing notifications in the vehicle app and a connection between the vehicle and a grid; and
updating the prediction based on the presence of at least one of the ongoing notifications in the vehicle app and the connection between the vehicle and the grid.

83. The method of claim 80, wherein the location of the vehicle comprises at least one of:
a parking place of the vehicle and a charging place of the vehicle.

84. The method of claim 83 further comprising:
determining the vehicle to be in at least one of: the parking place and the charging place based on at least one of input from a vehicle user in the vehicle app, detecting presence of a connection between the vehicle and a charging station, a geographical location of the vehicle based on global positioning system (GPS) coordinates, and one or more images of surroundings of the vehicle.

85. The method of claim 80, wherein the vehicle status comprises at least one of: running status, connection status, ignition status, lock status, and temperature status.

86. The method of claim 85 further comprising:
determining the running status of the vehicle based on information from an engine control unit;
detecting the connection status based on information from a battery management unit (BMU) of the vehicle;
determining the ignition status based on information from a body control module (BCM) of the vehicle;
determining the lock status based on information from the BCM of the vehicle; and
determining the temperature status of the vehicle based on information from one or more temperature sensors associated with the vehicle.

87. A method comprising:
obtaining a number of vehicle users associated with a vehicle;
obtaining a first information associated with user behavior for each of the vehicle users;
obtaining a second information associated with at least one of location of the vehicle, vehicle status, and weather conditions;
detecting patterns associated with usage of a vehicle app for each of the vehicle users based on the first information and the second information; and
modifying frequency of communication between the vehicle, the vehicle app, and a cloud server based on the detected patterns.

88. The method of claim 87 further comprising:
determining, for each of the vehicle user, a frequency of interaction with the vehicle app based on at least one of: a time period during a day, the location of the vehicle, and the vehicle status; and
obtaining the user behavior for each of the vehicle users based on the determination.
